(19) United States
(12) Patent Application Publication
(10) Pub. No.: US 2018/0268844 A1
(43) Pub. Date: Sep. 20, 2018

(54) SYNTACTIC SYSTEM FOR SOUND RECOGNITION

(71) Applicant: OtoSense Inc., Cambridge, MA (US)

(72) Inventors: Thor C. Whalen, Menlo Park, CA (US); Sebastien J.V. Christian, Mountain View, CA (US)

(73) Assignee: OtoSense Inc., Cambridge, MA (US)

(21) Appl. No.: 15/458,412

(22) Filed: Mar. 14, 2017

(51) Int. Cl. G10L 25/51; G10L 25/18; G10L 15/18; G10L 21/0388

(52) U.S. Cl. CPC G10L 25/51; G10L 21/0388; G10L 15/1815; G10L 25/18

(57) ABSTRACT

The disclosed embodiments provide a system that transforms a sound into a symbolic representation. During operation, the system extracts a sequence of tiles, comprising spectrogram slices, from the sound. Next, the system determines tile features for each tile in the sequence of tiles. The system then performs a clustering operation based on the tile features to identify clusters of tiles and to associate each tile with a cluster. Finally, the system associates each identified cluster with a unique symbol, and represents the sound as a sequence of symbols representing clusters, which are associated with the sequence of tiles.

### FIELD

The disclosed embodiments generally relate to the design of an automated system for recognizing sounds. More specifically, the disclosed embodiments relate to the design of an automated sound-recognition system that uses a syntactic pattern mining and grammar induction approach, transforming audio streams into structures of annotated and linked symbols.

### RELATED ART

Recent advances in computing technology have made it possible for computer systems to automatically recognize sounds, such as the sound of a gunshot, or the sound of a baby crying. This has led to the development of automated sound-recognition systems for detecting corresponding events, such as gunshot-detection systems and baby-monitoring systems. Existing sound-recognition systems typically operate by performing computationally expensive operations, such as time-warping sequences of sound samples to match known sound patterns. Moreover, these existing sound-recognition systems typically store sounds in raw form as sequences of sound samples, which is not searchable as is, and/or compute-indexed features of chunks of sound to make the sounds searchable, but extra-chunk and intra-chunk subtleties are lost.

Hence, what is needed is a system for automatically recognizing sounds without the above-described drawbacks of existing sound-recognition systems.

### SUMMARY

The disclosed embodiments provide a system for transforming sound into a symbolic representation. During this process, the system extracts small segments of sound, called tiles, and computes a feature vector for each tile. The system then performs a clustering operation on the collection of tile features to identify clusters of tiles, thereby providing a mapping between tiles to an associated cluster. The system associates each identified cluster with a unique symbol. Once fitted, this tiling plus features computation plus cluster mapping enables the system to represent any sound as a sequence of symbols representing the clusters associated with the sequence of audio tiles. We call this process “snipping.”

The tiling component can extract overlapping or non-overlapping tiles of regular or irregular size, and can be unsupervised or supervised. Tile features can be simple features, such as the segment of raw waveform samples themselves, a spectrogram, a mel-spectrogram, or a cepstrum decomposition, or more involved acoustic features computed therefrom. Clustering of the features can be centroid-based (such as k-means), connectivity-based, distribution-based, density-based, or in general any technique that can map the feature space to a finite set of symbols. In the following, we illustrate the system using the spectrogram decomposition over regular non-overlapping tiles and k-means as our clustering technique.

In some embodiments, while performing the normalization operation on the spectrogram slice, the system computes a sum of intensity values over the set of intensity values in the spectrogram slice. Next, the system divides each intensity value in the set of intensity values by the sum of intensity values. The system also stores the sum of intensity values in the spectrogram slice.

In some embodiments, while transforming each spectrogram slice, the system additionally performs a dimensionality-reduction operation on the spectrogram slice, which converts the set of intensity values for the set of frequency bands into a smaller set of values for a set of orthogonal basis vectors, which has a lower dimensionality than the set of frequency bands.

In some embodiments, while performing the dimensionality-reduction operation on the spectrogram slice, the system performs a principal component analysis (PCA) operation on the intensity values for the set of frequency bands.

In some embodiments, while transforming each spectrogram slice, the system identifies one or more highest-intensity frequency bands in the spectrogram slice. Next, the system stores the intensity values for the identified highest-intensity frequency bands in the spectrogram slice along with identifiers for the frequency bands.

In some embodiments, after the one or more highest-intensity frequency bands are identified for each spectrogram slice, the system normalizes the set of intensity values for the spectrogram slice with respect to intensity values for the highest-intensity frequency bands.

In some embodiments, while transforming each spectrogram slice, the system additionally boosts intensities for one or more components in the spectrogram slice.

In some embodiments, the system additionally segments the sequence of symbols into frequent patterns of symbol subsequences. The system then represents each segment using a unique symbol associated with a corresponding subsequence for the segment.

In some embodiments, the system identifies pattern-words in the sequence of symbols, wherein the pattern-words are defined by a learned vocabulary.

In some embodiments, the system associates the identified pattern-words with lower-level semantic tags.

In some embodiments, the system associates the lower-level semantic tags with higher-level semantic tags.

### BRIEF DESCRIPTION OF THE FIGURES

FIG. 1 illustrates a computing environment in accordance with the disclosed embodiments.

FIG. 2 illustrates a model-creation system in accordance with the disclosed embodiments.

FIG. 3 presents a diagram illustrating an exemplary sound-recognition process in accordance with the disclosed embodiments.

FIG. 4 presents a diagram illustrating another sound-recognition process in accordance with the disclosed embodiments.

FIG. 5A presents a flow chart illustrating a process for converting raw sound into a sequence of symbols associated with a sequence of spectrogram slices in accordance with the disclosed embodiments.

FIG. 5B presents a flow chart illustrating a process for generating semantic tags from a sequence of symbols in accordance with the disclosed embodiments.

FIG. 5C presents a flow chart illustrating a technique for normalizing spectrogram slices and reducing the dimensionality of the spectrogram slices in accordance with the disclosed embodiments.

FIG. 6 illustrates how a PCA operation is applied to a column in a matrix containing the spectrogram slices in accordance with the disclosed embodiments.

FIG. 7A illustrates an annotator in accordance with the disclosed embodiments.

FIG. 7B illustrates an exemplary annotator composition in accordance with the disclosed embodiments.

FIG. 7C illustrates an exemplary output of annotator composition illustrated in FIG. 7B in accordance with the disclosed embodiments.

### DETAILED DESCRIPTION

The following description is presented to enable any person skilled in the art to make and use the present embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present embodiments. Thus, the present embodiments are not limited to the embodiments shown, but are to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium. Furthermore, the methods and processes described below can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

### General Approach

In this disclosure, we describe a system that transforms sound into a “sound language” representation, which facilitates performing a number of operations on the sound, such as: general sound recognition; information retrieval; multi-level sound-generating activity detection; and classification. By the term “language” we mean both a formal and symbolic system for communication. During operation, the system processes an audio stream using a multi-level computational flow, which transforms the audio stream into a structure comprising interconnected informational units; from lower-level descriptors of the raw audio signals, to aggregates of these descriptors, to higher-level humanly interpretable classifications of sound facets, sound-generating sources or even sound-generating activities.

The system represents sounds using a language, complete with an alphabet, words, structures, and interpretations, so that a connection can be made with semantic representations. The system achieves this through a framework of annotators that associate segments of sound to properties thereof, and further annotators are also used to link annotations or sequences and collections thereof to properties. The tiling component is the entry annotator of the system that subdivides audio stream into tiles. Tile feature computation is an annotator that associates each tile to features thereof. The clustering of tile features is an annotator that maps tile features to snips drawn from a finite set of symbols. Thus, the snipping annotator, which is the composition of the tiling, feature computation, and clustering, annotates an audio stream into a stream of tiles annotated by snips. Further annotators annotate subsequences of tiles by mining the snip sequence for patterns. These bottom-up annotators create a language from an audio stream by generating a sequence of symbols (letters) as well as a structuring thereof (words, phrases, and syntax). Annotations can also be supervised; a user of the system can manually annotate segments of sounds, associating them with semantic information.

In a sound-recognition system that uses a sound language, as in natural-language processing, “words” are a means to an end: producing meaning. That is, the connection to natural language processing and semantics is bidirectional. We represent a sound in a language-like structured symbol sequence, which expresses the semantic content of the sound. Conversely, we can use targeted semantic categories (of sound-generating activities) to inform a language-like representation of the sound, which is able to efficiently and effectively express the semantics of interest for the sound.

Before describing details of this sound-recognition system, we first describe a computing system on which the sound-recognition system operates.

### Computing Environment

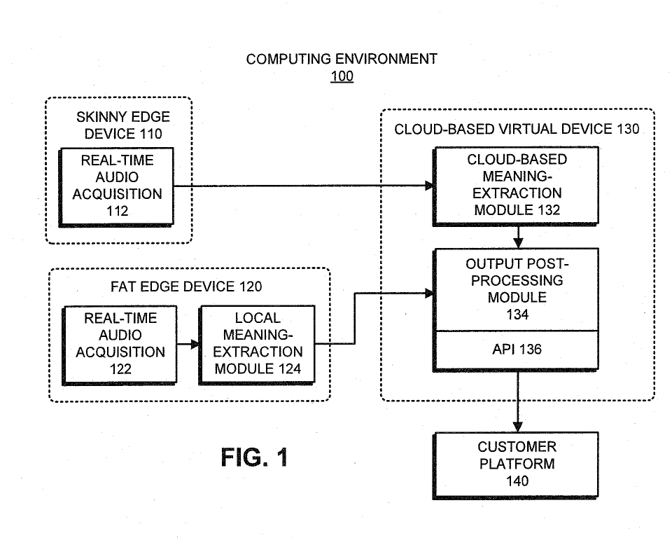

FIG. 1 illustrates a computing environment 100 in accordance with the disclosed embodiments. Computing environment 100 includes two types of device that can acquire sound, including a skinny edge device 110, such as a live-streaming camera, and a fat edge device 120, such as a smartphone or a tablet. Skinny edge device 110 includes a real-time audio acquisition unit 112, which can acquire and digitize an audio signal. However, skinny edge device 110 provides only limited computing power, so the audio signals are pushed to a cloud-based meaning-extraction module 132 inside a cloud-based virtual device 130 to perform meaning-extraction operations. Note that cloud-based virtual device 130 comprises a set of software resources that can be hosted on a remote enterprise-computing system.

Fat edge device 130 also includes a real-time audio acquisition unit 122, which can acquire and digitize an audio signal. However, in contrast to skinny edge device 110, fat edge device 120 possesses more internal computing power, so the audio signals can be processed locally in a local meaning-extraction module 124.

The output from both local meaning-extraction module 124 and cloud-based meaning-extraction module 132 feeds into an output post-processing module 134, which is also located inside cloud-based virtual device 130. This output post-processing module 134 provides an application programming interface (API) 136, which can be used to communicate results produced by the sound-recognition process to a customer platform 140.

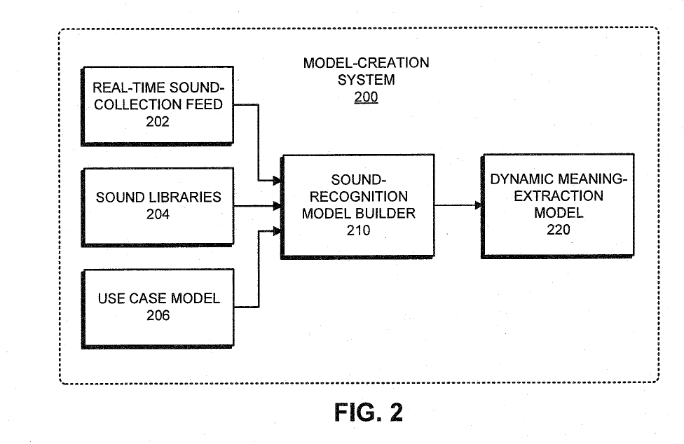

Referring to the model-creation system 200 illustrated in FIG. 2, both local meaning-extraction module 124 and cloud-based meaning-extraction module 132 make use of a dynamic meaning-extraction model 220, which is created by a sound-recognition model builder unit 210. This sound-recognition model builder unit 210 constructs and periodically updates dynamic meaning-extraction model 220 based on audio streams obtained from a real-time sound-collection feed 202 and from one or more sound libraries 204 and a use case model 206.

### Sound-Recognition Based on Sound Features

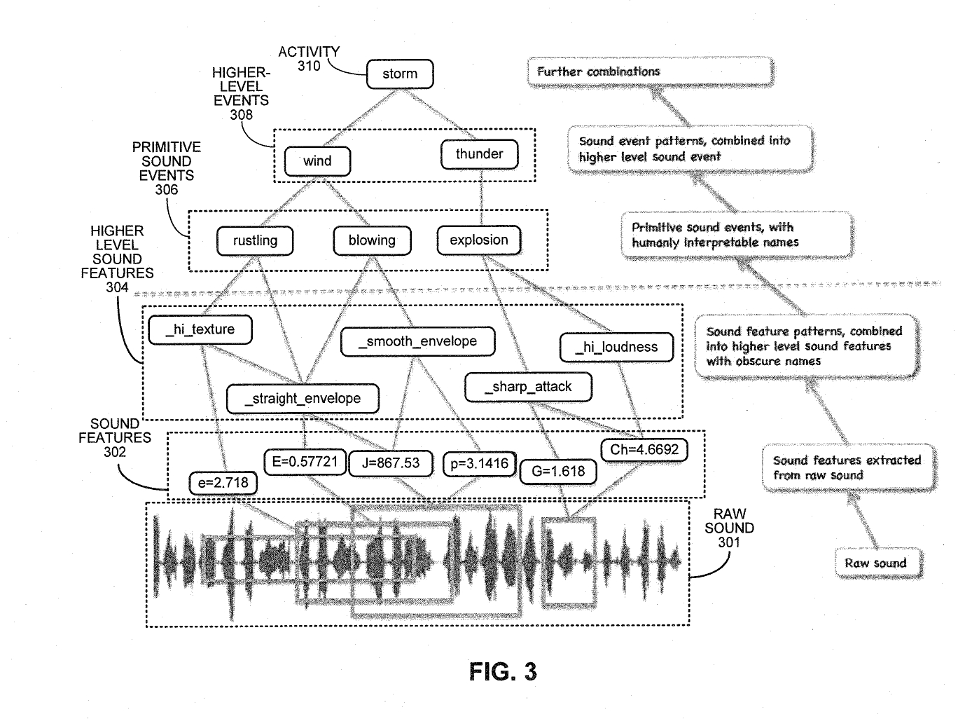

FIG. 3 presents a diagram illustrating an exemplary sound-recognition process that first converts raw sound into “sound features,” which are hierarchically combined and associated with semantic labels. Note that each of these sound features comprises a measurable characteristic for a window of consecutive sound samples. (For example, see U.S. patent application Ser. No. 15/256,236, entitled “Employing User Input to Facilitate Inferential Sound Recognition Based on Patterns of Sound Primitives” by the same inventors as the instant application, filed on 2 Sep. 2016, which is hereby incorporated herein by reference.) The system starts with an audio stream comprising raw sound 301. Next, the system extracts a set of sound features 302 from the raw sounds 301, wherein each sound feature is associated with a numerical value. The system then combines patterns of sound features into higher-level sound features 304, such as “_smooth_envelope,” or “_sharp_attack.” These higher-level sound features 304 are subsequently combined into primitive sound events 306, which are associated with semantic labels, and have a meaning that is understandable to people, such as a “rustling,” a “blowing” or an “explosion.” Next, these sound-primitive events 306 are combined into higher-level events 308. For example, rustling and blowing sounds can be combined into wind, and an explosion can be correlated with thunder. Finally, the higher-level sound events wind and thunder 308 can be combined into a recognized activity 310, such as a storm.

### Sound-Recognition Based on Sound Nips

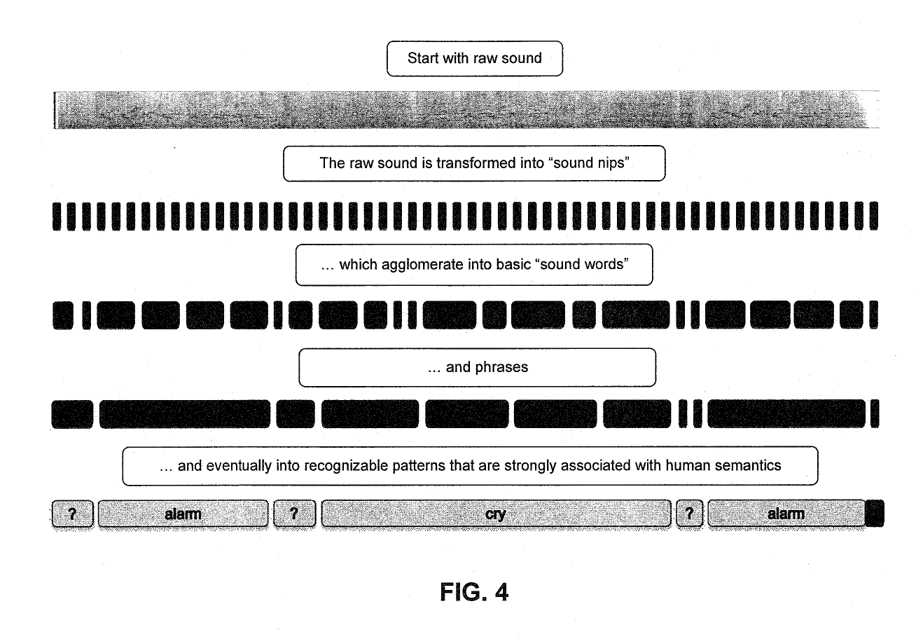

FIG. 4 presents a diagram illustrating another sound-recognition process that operates on snips (for “sound nips”) in accordance with the disclosed embodiments. As illustrated in FIG. 4, the system starts with raw sound. Next, the raw sound is transformed into snips. During this process, the system converts the sound into a sequence of tile features, for example spectrogram slices wherein each spectrogram slice comprises a set of intensity values for a set of frequency bands measured over a time interval. Next, the system uses a supervised and unsupervised learning process to associate each tile with a symbol (as is described in more detail below). The system then agglomerates the sound nips into “sound words,” which comprise patterns of symbols that are defined by a learned vocabulary. These words are then combined into phrases, and eventually into recognizable patterns, which are strongly associated with human semantic labels.

### Sound-Recognition Process

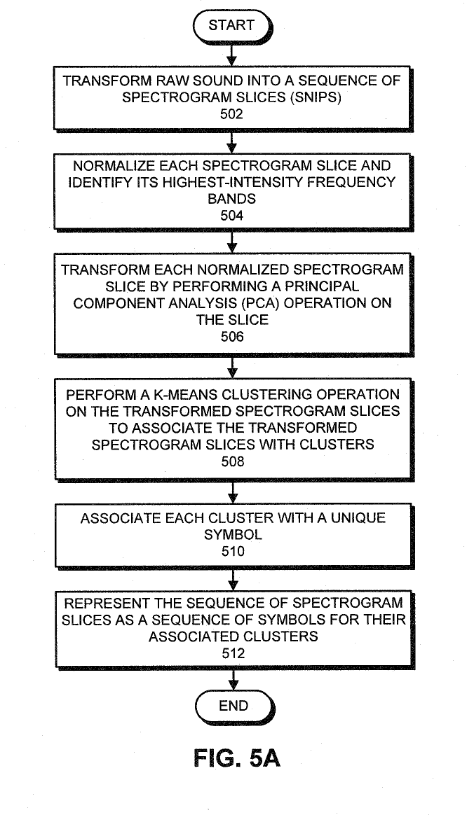

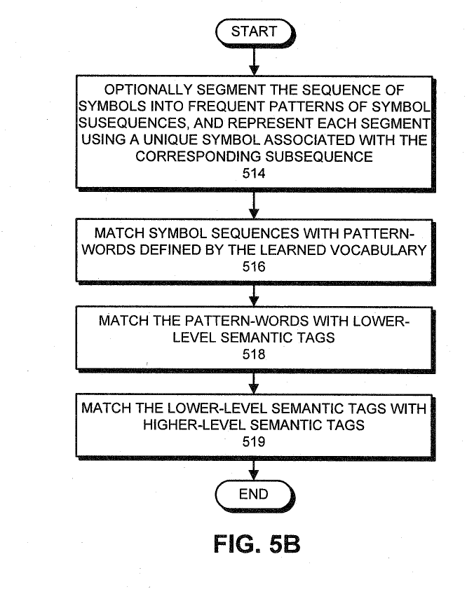

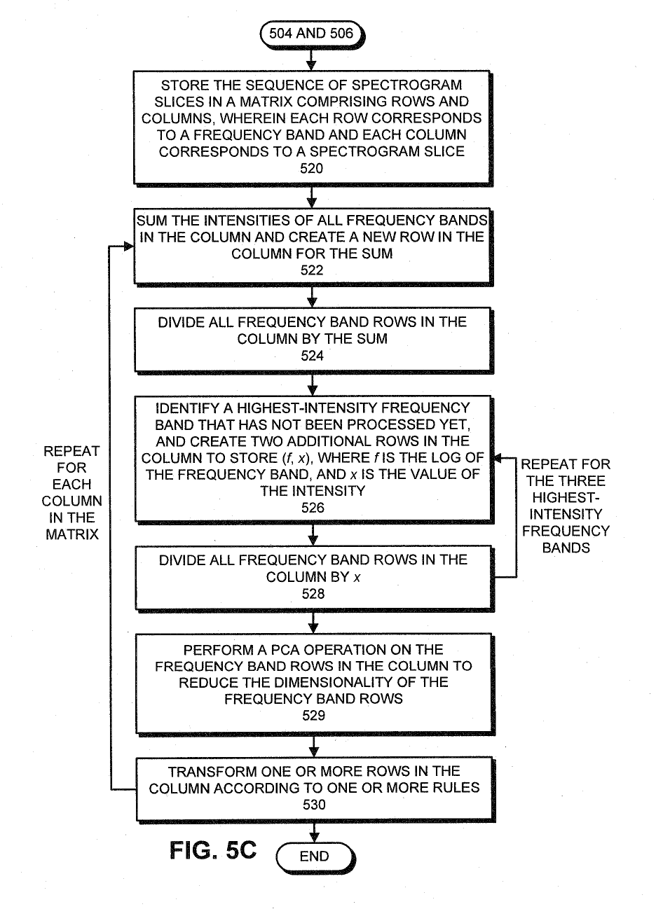

FIG. 5A presents a flow chart illustrating a process for converting raw sound into a sequence of symbols associated with spectrogram slices in accordance with the disclosed embodiments. First, the system transforms raw sound into a sequence of spectrogram slices (“snips”) (step 502). Recall that each spectrogram slice comprises a set of intensity values for a set of frequency bands (e.g., 128 frequency bands) measured over a given time interval (e.g., 46 milliseconds). Next, the system normalizes each spectrogram slice and identifies its highest-intensity frequency bands (step 504). The system then transforms each normalized spectrogram slice by performing a principal component analysis (PCA) operation on the slice (step 506). After the PCA operation is complete, the system performs a k-means clustering operation on the transformed spectrogram slices to associate the transformed spectrogram slices with centroids of the clusters (step 508). The system also associates each cluster with a unique symbol (step 510). For example, there might exist 8,000 clusters, in which case the system will use 8,000 unique symbols to represent the 8,000 clusters. Finally, the system represents the sequence of spectrogram slices as a sequence of symbols for their associated clusters (step 512).

Note that the sequence of symbols can be used to reconstruct the sound. However, some accuracy will be lost during the reconstruction because the center of a centroid is likely to differ somewhat from the actual spectrogram slice that mapped to the centroid. Also note that the sequence of symbols is much more compact than the original sequence of spectrogram slices, and the sequence of symbols can be stored in a canonical representation, such as Unicode. Moreover, the sequence of symbols is easy to search, for example by using regular expressions. Also, by using the symbols we can generate higher-level structures, which can be associated with semantic tags as is described in more detail below.

FIG. 5B presents a flow chart illustrating a process for generating semantic tags from a sequence of symbols in accordance with the disclosed embodiments. In an optional first step, the system segments the sequence of symbols into frequent patterns of symbol subsequences, and represents each segment using a unique symbol associated with the corresponding subsequence (step 514). In general, any type of segmentation technique can be used. For example, we can look for commonly occurring short subsequences of symbols (such as bigrams, trigrams, quadgrams, etc.) and can segment the sequence of symbols based on these commonly occurring short subsequences. More generally, each symbol is mapped to a vector of weighted related symbols and areas of high density in this vector space are detected and annotated (becoming the pattern-words of our language). Next, the system matches symbol sequences with pattern-words defined by this learned vocabulary (step 516). The system then matches the pattern-words with lower-level semantic tags (step 518). Finally, the system matches the lower-level semantic tags with higher-level semantic tags (step 519).

FIG. 5C presents a flow chart illustrating a technique for normalizing spectrogram slices and reducing the dimensionality of the normalized spectrogram slices in accordance with the disclosed embodiments. At the start of this process, the system first stores the sequence of spectrogram slices in a matrix comprising rows and columns, wherein each row corresponds to a frequency band and each column corresponds to a spectrogram slice (step 520).

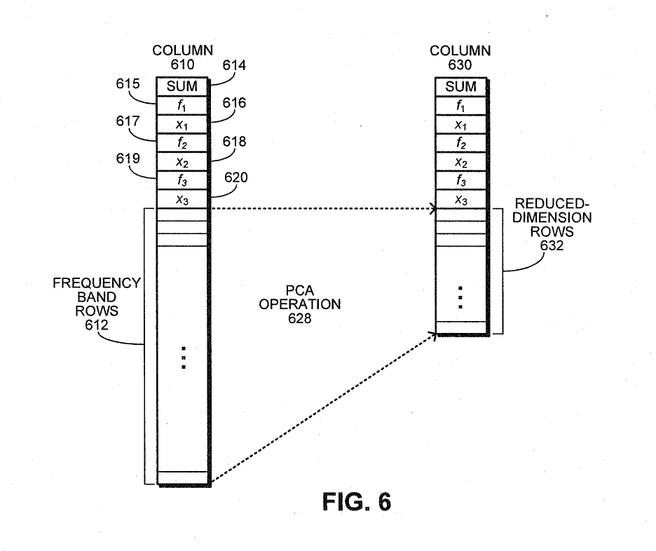

The system then repeats the following operations for all columns in the matrix. First, the system sums the intensities of all of the frequency bands in the column and creates a new row in the column for the sum (step 522). (See FIG. 6, which illustrates a column 610 containing a set of frequency band rows 612, and also a row-entry for the sum of the intensities of all the frequency bands 614.) Next, the system divides all of the frequency band rows 612 in the column by the sum 614 (step 524).

The system then repeats the following steps for the three highest-intensity frequency bands. The system first identifies the highest-intensity frequency band that has not been processed yet, and creates two additional rows in the column to store (f, x), where f is the log of the frequency band, and x is the value of the intensity (step 526). (See the six row entries 615-620 in FIG. 6, which store f and x values for the three highest-intensity bands, namely (f₁, x₁, f₂, x₂, f₃, and x₃). The system also divides all the frequency band rows in the column by x (step 528).

After the three highest-intensity frequency bands are processed, the system performs a PCA operation on the frequency band rows in the column to reduce the dimensionality of the frequency band rows (step 529). (See PCA operation 628 in FIG. 6, which reduces the frequency band rows 612 into a smaller number of reduced dimension rows 632 in a reduced column 630.) Finally, the system transforms one or more rows in the column according to one or more rules (step 530). For example, the system can increase the value stored in the sum row-entry 614 because that stores the sum of the intensities, so the sum is more significant in subsequent processing.

### Annotator

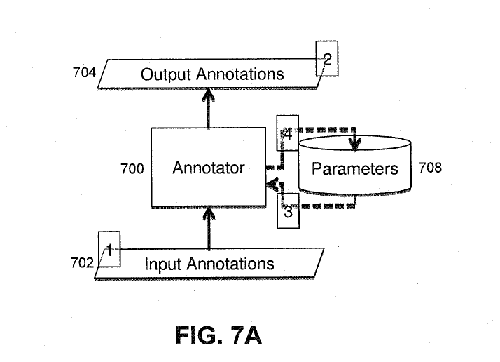

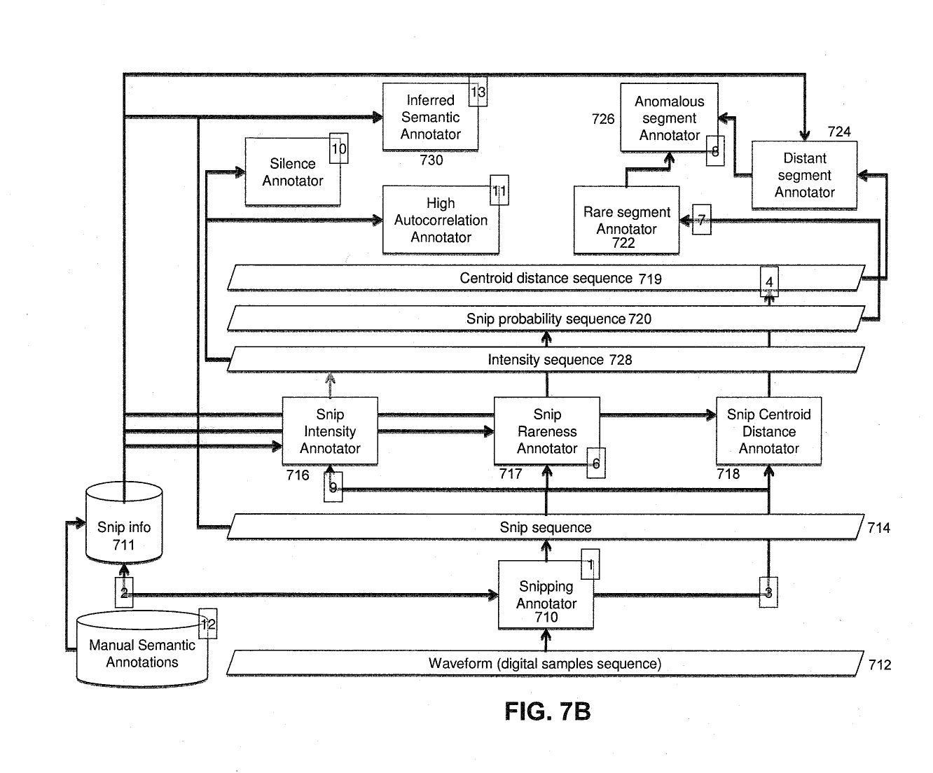

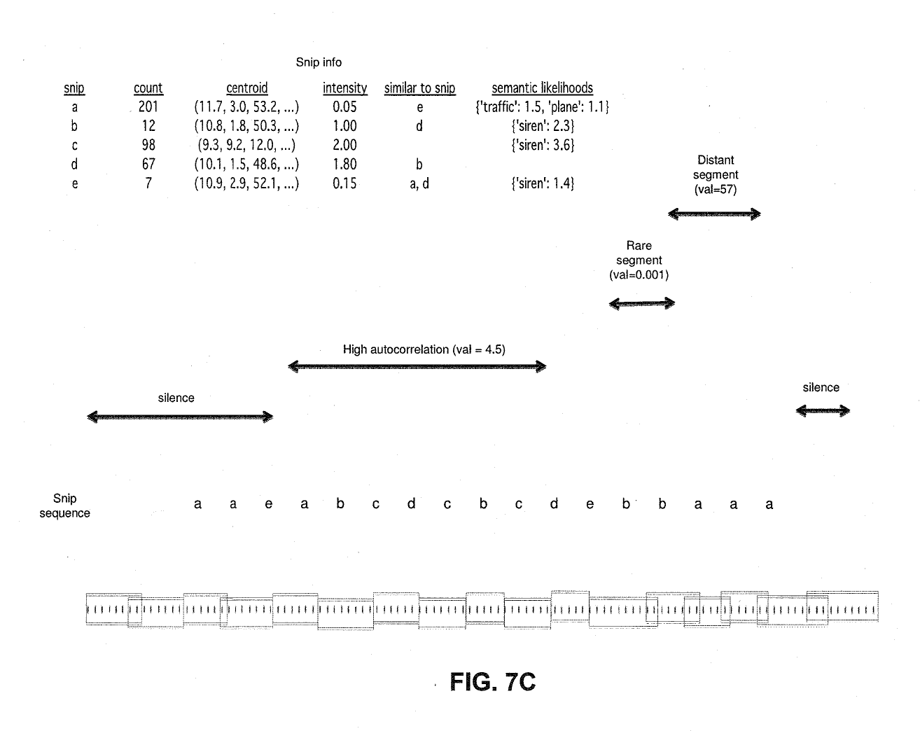

FIG. 7A illustrates an exemplary annotator 700, which is used to annotate snips and segments in accordance with the disclosed embodiments. More specifically, FIG. 7A illustrates how the annotator 700 receives input annotations 702, and produces output annotations 704 based on various parameters 708.

FIG. 7B illustrates an exemplary annotator composition in accordance with the disclosed embodiments. This figure illustrates how the system starts with waveforms, and then produces tile snips (which can be thought of as the first annotation of the waveform), to tile/snip annotations to segment annotations. More specifically referring to FIG. 7B, the snipping annotator 710 (also referred to as “the snipper”), whose parameters are assumed to have already been learned, takes an input waveform 712, extracts tiles of consecutive wave form samples, computes a feature vector for that tile, finds the snip that is closest to that feature vector, and assigns that snip to it (that is, the property of the tile is the snip). Thus, the snipping annotator 710 essentially produces a sequence of tile snips 714 from the waveform 712.

As the snipping annotator 710 consumes and tiles waveforms, useful statistics are maintained in the snip info database 711. In particular, the snipping annotator 710 updates a snip count and a mean and variance of the distance of the encountered tile feature vector to the feature centroid of snip that the tile was assigned to. This information is used by downstream annotators.

Note that the feature vector and snip of each tile extracted by the snipping annotator 710 is fed to the snip centroid distance annotator 718. The snip centroid distance annotator 718 computes the distance of the tile feature vector to the snip centroid, producing a sequence of “centroid distance” annotations 719 for each tile. Using the mean and variance distance to a snip's feature centroid, the distant segment annotator 724 decides when a window of tiles has enough accumulated distance to annotate it. These segment annotations reflect how anomalous the segment is, or detect when segments are not well represented by the current snipping rules. Using the (constantly updating) snip counts of snip information, the snip rareness annotator 717 generates a sequence of snip probabilities 720 from the sequence of tile snips 714. The rare segment annotator 722 detects when there exists a high density of rare snips and generates annotations for rare segments. The anomalous segment annotator 726 aggregates the information received from the distant segment annotator 724 and the rare segment annotator 722 to decide which segments to mark as “anomalous,” along with a value indicating how anomalous the segment is.

Note that the snip information has the feature centroid of each snip, of which can be extracted or computed the (mean) intensity for that snip. The snip intensity annotator 716 takes the sequence of snips and generates a sequence of intensities 728. The intensity sequence 728 is used to detect and annotate segments that are consistently low in intensity (e.g., “silent”). The intensity sequence 728 is also used to detect and annotate segments that are over a given threshold of (intensity) autocorrelation. These annotations are marked with a value indicating the autocorrelation level.

The audio source is provided with semantic information, and specific segments can be marked with words describing their contents and categories. These are absorbed, stored in the database (as annotations), and the co-occurrence snips and categories is counted and the likelihood of the categories associated with each snip in the snip information data. Using the category likelihoods associated with the snips, the inferred semantic annotator 730 marks segments that have a high likelihood of being associated to any of the targeted categories.

FIG. 7C illustrates an exemplary output of annotator composition illustrated in FIG. 2 in accordance with the disclosed embodiments. FIG. 7C also includes a tables showing the “snip info” that is used to create each annotation.

### Operations on Sequences of Symbols

After a set of sounds is converted into corresponding sequences of symbols, various operations can be performed on the sequences. For example, we can generate a histogram, which specifies the number of times each symbol occurs in the sound. For example, suppose we start with a collection of n “sounds,” wherein each sound comprises an audio signal which is between one second and several minutes in length. Next, we convert each of these sounds into a sequence of symbols (or words) using the process outlined above. Then, we count the number of times each symbol occurs in these sounds, and we store these counts in a “count matrix,” which includes a row for each symbol (or word) and a column for each sound. Next, for a given sound, we can identify the other sounds that are similar to it. This can be accomplished by considering each column in the count matrix to be a vector and performing “cosine similarity” computations between a vector for the given sound and vectors for the other sounds in the count matrix. After we identify the closest sounds, we can examine semantic tags associated with the closest sounds to determine which semantic tags are likely to be associated with the given sound.

We can further refine this analysis by computing a term frequency-inverse document frequency (TF-IDF) statistic for each symbol (or word), and then weighting the vector component for the symbol (or word) based on the statistic. Note that this TF-IDF weighting factor increases proportionally with the number of times a symbol appears in the sound, but is offset by the frequency of the symbol across all of the sounds. This helps to adjust for the fact that some symbols appear more frequently in general.

We can also smooth out the histogram for each sound by applying a “confusion matrix” to the sequence of symbols. This confusion matrix says that if a given symbol A exists in a sequence of symbols, there is a probability (based on a preceding pattern of symbols) that the symbol is actually a B or a C. We can then replace one value in the row for the symbol A with corresponding fractional values in the rows for symbols A, B and C, wherein these fractional values reflect the relative probabilities for symbols A, B and C.

We can also perform a “topic analysis” on a sequence of symbols to associate runs of symbols in the sequence with specific topics. Topic analysis assumes that the symbols are generated by a “topic,” which comprises a stochastic model that uses probabilities (and conditional probabilities) for symbols to generate the sequence of symbols.

Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

The foregoing descriptions of embodiments have been presented for purposes of illustration and description only. They are not intended to be exhaustive or to limit the present description to the forms disclosed. Accordingly, many modifications and variations will be apparent to practitioners skilled in the art. Additionally, the above disclosure is not intended to limit the present description. The scope of the present description is defined by the appended claims.

1. A method for transforming sound into a symbolic representation to create a sound language to facilitate subsequent operations on the sound, the method comprising:
extracting a sequence of tiles, comprising spectrogram slices, from the sound;
determining tile features for each tile in the sequence of tiles;
performing a clustering operation based on the tile features to identify clusters of tiles and to associate each tile with a cluster;
associating each identified cluster with a unique symbol;
representing the sound as a sequence of symbols representing clusters, which are associated with the sequence of tiles, wherein the sequence of symbols comprise words and structures in a sound language; and
performing a subsequent operation on the sequence of symbols.

2. The method of claim 1, wherein extracting the sequence of tiles involves performing non-overlapping tiling and using a spectrogram decomposition operation, which involves:
converting the sound into the sequence of tiles comprising spectrogram slices, wherein each spectrogram slice comprises a set of intensity values for a set of frequency bands measured over a time interval;
transforming each tile in the sequence of tiles by performing one or more operations on the tile, including performing a normalization operation on the tile;
computing a sum of intensity values over the set of intensity values in the tile;
dividing each intensity value in the set of intensity values by the sum of intensity values; and
storing the sum of intensity values in the tile.

3. The method of claim 2, wherein transforming each tile further comprises performing a dimensionality-reduction operation on the tile, which converts the set of intensity values for the set of frequency bands into a smaller set of values for a set of orthogonal basis vectors, which has a lower dimensionality than the set of frequency bands.

4. The method of claim 3, wherein performing the dimensionality-reduction operation on the tile involves performing a principal component analysis (PCA) operation on the intensity values for the set of frequency bands.

5. The method of claim 2, wherein transforming each tile further comprises:
identifying one or more highest-intensity frequency bands in the tile; and
storing the intensity values for the identified highest-intensity frequency bands in the tile along with identifiers for the frequency bands.

6. The method of claim 5, wherein after the one or more highest-intensity frequency bands are identified for each tile, the method further comprises normalizing the set of intensity values for the tile with respect to intensity values for the one or more highest-intensity frequency bands.

7. The method of claim 2, wherein transforming each tile further comprises boosting intensities for one or more components in the tile.

8. The method of claim 1, wherein the method further comprises:
segmenting the sequence of symbols into frequent patterns of symbol subsequences; and
representing each segment using a unique symbol associated with a corresponding subsequence for the segment.

9. The method of claim 1, wherein the method further comprises identifying pattern-words in the sequence of symbols, wherein the pattern-words are defined by a learned vocabulary.

10. The method of claim 8, wherein the method further comprises associating the identified pattern-words with lower-level semantic tags.

11. The method of claim 9, wherein the method further comprises associating the lower-level semantic tags with higher-level semantic tags.

12. The method of claim 1, wherein the method further comprises using one or more annotators to generate one or more annotations for each tile.

13. The method of claim 12, wherein the one or more annotations for a tile can include, a centroid distance for the tile, a tile probability, and a tile intensity.

14. A non-transitory computer-readable storage medium storing instructions that when executed by a computer cause the computer to perform a method for transforming sound into a symbolic representation to create a sound language to facilitate subsequent operations on the sound, the method comprising:
extracting a sequence of tiles, comprising spectrogram slices, from the sound;
determining tile features for each tile in the sequence of tiles;
performing a clustering operation based on the tile features to identify clusters of tiles and to associate each tile with a cluster;
associating each identified cluster with a unique symbol;
representing the sound as a sequence of symbols representing clusters, which are associated with the sequence of tiles, wherein the sequence of symbols comprise words and structures in a sound language; and
performing a subsequent operation on the sequence of symbols.

15. The non-transitory computer-readable storage medium of claim 14, wherein determining the tile features for each tile involves:
computing a sum of intensity values over the set of intensity values in the tile;
dividing each intensity value in the set of intensity values by the sum of intensity values; and
storing the sum of intensity values in the tile.

16. The non-transitory computer-readable storage medium of claim 14, wherein determining the tile features for each tile further comprises performing a dimensionality-reduction operation on the tile, which converts the set of intensity values for the set of frequency bands into a smaller set of values for a set of orthogonal basis vectors, which has a lower dimensionality than the set of frequency bands.

17. The non-transitory computer-readable storage medium of claim 16, wherein performing the dimensionality-reduction operation on the tile involves performing a principal component analysis (PCA) operation on the intensity values for the set of frequency bands.

18. The non-transitory computer-readable storage medium of claim 14, wherein determining the tile features for each tile further comprises:
identifying one or more highest-intensity frequency bands in the tile; and
storing the intensity values for the identified highest-intensity frequency bands in the tile along with identifiers for the frequency bands.

19. The non-transitory computer-readable storage medium of claim 18, wherein after the one or more highest-intensity frequency bands are identified for each tile, the method further comprises normalizing the set of intensity values for the tile with respect to intensity values for the one or more highest-intensity frequency bands.

20. The non-transitory computer-readable storage medium of claim 14, wherein transforming each tile further comprises boosting intensities for one or more components in the tile.

21. The non-transitory computer-readable storage medium of claim 14, wherein the method further comprises:
segmenting the sequence of symbols into frequent patterns of symbol subsequences; and
representing each segment using a unique symbol associated with a corresponding subsequence for the segment.

22. The non-transitory computer-readable storage medium of claim 14, wherein the method further comprises identifying pattern-words in the sequence of symbols, wherein the pattern-words are defined by a learned vocabulary.

23. The non-transitory computer-readable storage medium of claim 22, wherein the method further comprises associating the identified pattern-words with lower-level semantic tags.

24. The non-transitory computer-readable storage medium of claim 23, wherein the method further comprises associating the lower-level semantic tags with higher-level semantic tags.

25. The non-transitory computer-readable storage medium of claim 14, wherein the method further comprises using one or more annotators to generate one or more annotations for each tile.

26. The non-transitory computer-readable storage medium of claim 25, wherein the one or more annotations for a snip can include, a centroid distance for the tile, a tile probability, and a tile intensity.

27. A system that transforms sound into a symbolic representation to create a sound language to facilitate subsequent operations on the sound, the system comprising:
at least one processor and at least one associated memory; and
a sound-transformation mechanism that executes on the at least one processor, wherein during operation, the sound-transformation mechanism:
extracts a sequence of tiles, comprising spectrogram slices, from the sound;
determines tile features for each tile in the sequence of tiles;
performs a clustering operation based on the tile features to identify clusters of tiles and to associate each tile with a cluster;
associates each identified cluster with a unique symbol; and
represents the sound as a sequence of symbols representing clusters, which are associated with the sequence of tiles, wherein the sequence of symbols comprise words and structures in a sound language; and
performing a subsequent operation on the sequence of symbols.

28. The system of claim 27, wherein while determining the tile features for each tile, the sound-transformation mechanism performs a normalization operation on each tile, which involves:
computing a sum of intensity values over the set of intensity values in the tile;
dividing each intensity value in the set of intensity values by the sum of intensity values; and
storing the sum of intensity values in the tile.

29. The system of claim 27, wherein while determining the tile features for each tile, the sound-transformation mechanism performs a dimensionality-reduction operation on the tile, which converts the set of intensity values for the set of frequency bands into a smaller set of values for a set of orthogonal basis vectors, which has a lower dimensionality than the set of frequency bands.

30. The system of claim 27, wherein while determining the tile features for each tile, the sound-transformation mechanism additionally:
identifies one or more highest-intensity frequency bands in the tile; and
stores the intensity values for the identified highest-intensity frequency bands in the tile along with identifiers for the frequency bands.

31. The system of claim 27, wherein the sound-transformation mechanism additionally:
segments the sequence of symbols into frequent patterns of symbol subsequences; and
represents each segment using a unique symbol associated with a corresponding subsequence for the segment.

32. The system of claim 27, wherein the system further comprises a symbol-processing mechanism, which identifies pattern-words in the sequence of symbols, wherein the pattern-words are defined by a learned vocabulary.

33. The system of claim 32, wherein the symbol-processing mechanism additionally associates the identified pattern-words with lower-level semantic tags.

34. The system of claim 33, wherein the symbol-processing mechanism additionally associates the lower-level semantic tags with higher-level semantic tags.
